(19) United States
(12) Patent Application Publication
(10) Pub. No.: US 2001/0023490 A1
(43) Pub. Date: Sep. 20, 2001

(54) Method for activating a JTAG interface of a microprocessor of a microcontroller upon which a JTAG interface is implemented, and microcontroller

(76) Inventors: Klaus Gloeckler, Asperg (DE); Claus Moessner, Ispringen (DE); Axel Aue, Korntal-Muenchingen (DE)

Correspondence Address: KENYON & KENYON, ONE BROADWAY, NEW YORK, NY, 10004, US

(21) Appl. No.: 09/758,675

(22) Filed: Jan. 11, 2001

(30) Foreign Application Priority Data
Jan. 11, 2000 (DE) 100 00 785.6

(51) Int. Cl. G06F 11/26

(52) U.S. Cl. 714/30

(57) ABSTRACT

A method for activating a microprocessor, which is part of a microcontroller, within the framework of a boundary scan test procedure according to Institute of Electrical and Electronic Engineers (IEEE) standard 1149, using a Joint European Test Action Group (JTAG) interface of the microprocessor. To be able to test a microcontroller, using the boundary scan test procedure, even when the JTAG interface is not accessible by a separate hardware adaptor of a JTAG tester, it is proposed that the JTAG interface of the microprocessor be activated by a test routine executable on the microprocessor.

### FIELD OF THE INVENTION

The present invention relates to a method for activating a microprocessor which is part of a microcontroller, within the framework of a boundary scan test procedure according to Institute of Electrical and Electronic Engineers (IEEE) Standard 1149, using a Joint European Test Action Group (JTAG) interface of the microprocessor. Furthermore, the present invention relates to a microcontroller having at least one microprocessor, which can be controlled by a JTAG interface, within the framework of a boundary scan test procedure according to IEEE Standard 1149.

### BACKGROUND INFORMATION

The boundary scan test procedure according to IEEE Standard 1149 has been known for some time from the related art. The boundary scan test procedure is used for testing the connection between two semiconductor components, e.g. between a microcontroller and external drivers of the microcontroller. The boundary scan has the advantage that the electronic semiconductor components to be tested do not have to be accessed directly, for example, using a test probe (e.g. of a bed-of-nails adaptor) from the outside, but rather that access to the electronic semiconductor components takes place via the JTAG interface of the semiconductor element. The boundary scan is described in detail in the related art, as, for instance, in the information paper of SUN MICROELECTRONICS, Mountain View, Calif., USA, “Introduction to JTAG Boundary-Scan”, White Paper, January 1997, Part No. WPR-0018-01, and on the Internet on the web page “Analoges Boundary Scan, IEEE P1149.4”. Reference is made expressly to both these expositions.

The present invention relates more particularly to the boundary scan in the case of semiconductor components configured as microprocessors. The microprocessors are parts of a microcontroller, which in turn is part of a control unit for a motor vehicle. The control units are used for controlling/regulating certain functions of a motor vehicle, for instance, of the internal combustion engine, the brakes, the transmission, the chassis, the operating dynamics, or heating/air conditioning of the passenger compartment.

According to the related art, the JTAG interface is contacted via pins. With the use of a hardware adaptor of a JTAG tester, which is connected to the JTAG interface, the pins are observable and/or controllable from the outside. A test data stream for the microcontroller or for the microprocessor is made available to the JTAG interface via the hardware adaptor, in accordance with a stipulated test sequence of the boundary scan test method. Therefore, in accordance with known methods heretofore, the JTAG interface is freely accessible from the outside, in order for the boundary scan test method to be carried out, enabling the hardware adaptor to be connected.

Therefore, the application of the boundary scan test method does not come into consideration for microcontrollers which are positioned in a housing, or for those where the JTAG interface, when ready for use, is not freely accessible for other reasons. Thus, according to the related art, control devices for motor vehicles having, in part, complex microcontrollers, are also not able to be tested using the boundary scan test method, since the control device, when ready for use, is enclosed in a housing, and it is not possible for the JTAG interface to be contacted from the outside using a hardware adaptor. Therefore, to check test the reliability performance of control devices for motor vehicles, known methods heretofore require extensive functional tests, which are relatively time-consuming and costly.

### SUMMARY OF THE INVENTION

It is therefore an object of the present invention to develop and further refine a method, or rather a microcontroller of the kind mentioned at the outset, to the effect that the proper functioning of the microcontroller can be check tested using the boundary scan test method even when the JTAG interface of the microprocessor is not freely accessible.

To achieve this object, the present invention proposes, starting out from the method of the kind mentioned at the outset, that the microprocessor's JTAG interface be activated by a test routine that is executable on the microprocessor.

The present invention proposes not activating the JTAG interface via a separate hardware adaptor of a JTAG tester, but rather, providing a special test routine in the microprocessor, which will enable the JTAG interface to be activated within the framework of a boundary scan test procedure. Thus, the present invention proposes using a test routine to emulate the function of a JTAG tester and executing the test routine on the microprocessor to carry out the boundary scan test procedure.

The test routine is initiated when needed for test purposes. To execute the routine, the microcontroller is switched over into JTAG test mode. The test routine is stored in an internal or external memory of the microprocessor, and, in the test mode, it is copied into the internal program memory of the microprocessor (e.g. a random access memory, or RAM). Alternatively, the test routine can also be stored in an internal flash memory of the microprocessor, where it can be directly executed in the test mode. The routine contains control commands for activating the pins of the JTAG interface, and test data which are transmitted via the JTAG interface to the microprocessor, or rather to the microcontroller. Once the boundary scan test procedure is concluded, the microcontroller's JTAG test mode is terminated. To do this, the reset (RST)-input of the JTAG interface is preferably set.

The advantage of the method according to the present invention is that a microcontroller's reliability performance can be tested even when the microprocessor's JTAG interface is not readily accessible from the outside. That is important, for example, when testing control units having complex microcontrollers, as, for instance, the ones that are used for controlling/regulating certain functions in a motor vehicle. Using the method according to the present invention, a control unit can be checked for proper functioning without having to perform extensive function tests. In particular, one can test the connections of the control unit's microcontroller to the external drivers. Using the boundary scan test procedure, which, at this point, can be performed on control devices, one can attain a substantially higher test coverage. In addition, the method according to the present invention leads to a reduction in the test time, since certain function tests are replaced by the boundary scan test procedure, and can, therefore, be omitted.

One advantageous further refinement of the present invention proposes connecting the input-output (I/O) ports of the microprocessor to the pins of the JTAG interface, and having the test routine control the pins of the JTAG interface via the I/O ports. The I/O ports of the microprocessor are designed, for instance, as PAD cells having an I/O port function. The microprocessor uses the PAD cells as input inverters or as output drivers.

The microprocessor's I/O ports can be switched over between an input mode and an output mode by the appropriate control commands of the test routine. When the PAD cells are switched to input mode, they are connected to output pins (e.g. data out (DO)) of the JTAG interface, and can record values present at the pins. When the PAD cells are switched to output mode, they are connected to input pins (e.g. data in (DI)) of the JTAG interface, and test data can be transmitted, via the pins, to the microprocessor or the microcontroller. This kind of activation of the pins of the JTAG interface as I/O ports demonstrates a particularly simple implementation. However, a plurality of other implementations is conceivable for activating the pins of the JTAG interface by a test routine executable on the microprocessor.

The pins of the JTAG interface are advantageously set and/or read by the test routine, according to a stipulated test sequence in the test routine. Via the I/O ports, which are switched as outputs, a predefined test data stream can be transmitted across the JTAG interface to the microprocessor or the microcontroller. The levels present can then be measured at the pins of an interface of the microcontroller, which can be accessed from the outside, for instance, using a test adaptor. The levels present at these pins of the microcontroller's interface are dependent on the test data stream, which is input by the test routine via the pins (DI) of the JTAG interface to the microprocessor or the microcontroller, and on the performance reliability of the microcontroller.

The values present at the pins of the JTAG interface can be read via the I/O ports, which are switched as inputs. The values read can either be immediately further processed, or, for the time-being, temporarily stored for later processing. If at least one of the I/O ports is switched as input, by using the test adaptor, determined values can be applied to the microcontroller or the microprocessor, via the microcontroller's interface. The values present at the pins (DO) of the JTAG interface are dependent upon the values present at the microcontroller's interface and on its performance reliability.

One preferred embodiment of the present invention proposes that a test data stream be made available to the JTAG interface by the test routine, within the scope of the boundary scan test procedure. With the help of the test data stream, defined test data patterns can be applied to the microprocessor or the microcontroller, in order to thereby simulate defined functions of the microcontroller and to check test the microcontroller's performance reliability.

A further advantageous specific embodiment of the present invention proposes that the test routine switch the I/O ports of the microprocessor to output ports and set them to high for a specified duration, the levels present at an interface of the microcontroller being measured. The microcontroller's interface is designed, for example, as a scalable coherent interface (SCI). The levels present at the of the microcontroller's interface are measured, for instance, using a test adaptor.

It is further proposed that the test routine switch the microprocessor's I/O ports to input ports for a specified duration, defined values being applied to the microcontroller's interface in accordance with a set operational sequence. The values are applied to the microcontroller's interface, for example, using a test adaptor. Depending on the values present at the microcontroller's interface, defined values are read out at the pins (DO) of the JTAG interface, which are read by the microprocessor's I/O port, which has been switched to input port and is connected to the pins of the JTAG interface.

The values present at the pins of the JTAG interface are advantageously read via the microprocessor's I/O ports and stored in a memory area of the microcontroller. The memory area is, for example, an internal write/read memory having random access memory (RAM) of the microprocessor. In connection with the boundary scan procedure, the values stored in the memory area are preferably read out via the microcontroller's interface. The values read out can then be processed further in a test unit.

A preferred specific embodiment of the present invention proposes that the method according to the present invention be used for check testing the microcontroller of a motor vehicle's control unit.

As another way to attain the object of the present invention, starting from the microcontroller of the kind mentioned at the outset, it is proposed that at least one microprocessor have an arrangement for activating the microprocessor's JTAG interface by a test routine which is executable on the microprocessor. In this manner, using a simple modification of the microprocessor's JTAG interface, the boundary scan test procedure can also be applied to such microcontrollers, when the JTAG interface is not freely accessible from the outside.

One advantageous further development of the present invention proposes that the arrangement include PAD cells of the microprocessor and connecting leads from the PAD cells to the pins of the JTAG interface, the PAD cells having an input/output (I/O) function. The microprocessor uses the PAD cells as input inverters or output drivers. The PAD cells are each connected to certain pins of the JTAG interface. By switching the PAD cells as input ports, the values present at the pins of the JTAG interface can be read, and by switching them as output ports, defined values can be applied to the pins of the JTAG interface.

One preferred specific embodiment of the present invention proposes that the microcontroller have an interface, where the levels present can be measured, or, as the case may be, defined values can be applied, from outside the microcontroller. The microcontroller's interface is preferably designed as a scalable coherent interface (SCI).

### BRIEF DESCRIPTION OF THE DRAWINGS

FIG. 1 shows a microprocessor of a microcontroller according to the present invention, corresponding to a preferred specific embodiment.

FIG. 2 shows a flow chart of the method according to the present invention, corresponding to a preferred specific embodiment.

### DETAILED DESCRIPTION

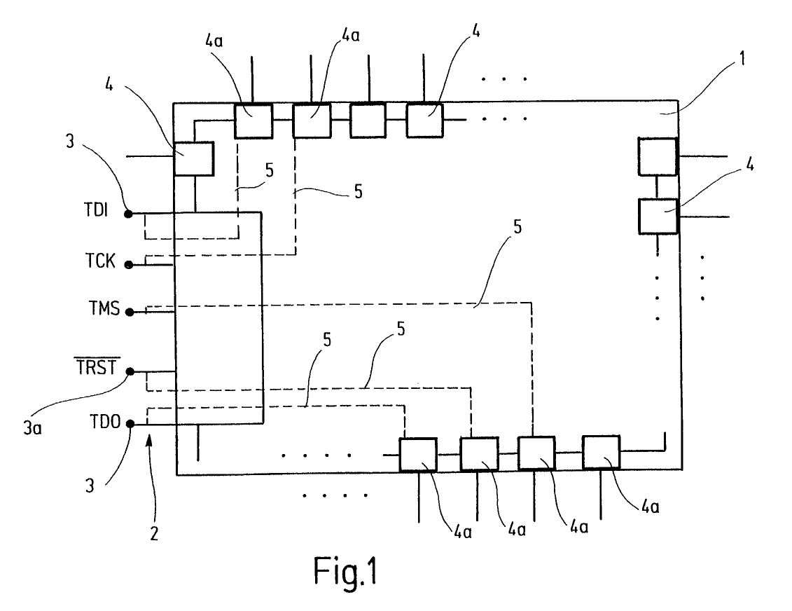

FIG. 1 shows a microprocessor of a microcontroller according to the present invention, marked in its entirety by reference numeral 1. Microprocessor 1 is one of a plurality of the microcontroller's electronic semiconductor components. The microcontroller is a component of a control unit for a motor vehicle. The control unit controls or regulates specific motor vehicle functions, e.g. the internal combustion engine, the transmission, the brakes, the chassis, the operating dynamics or the heating/air-conditioning of the passenger compartment. Control units have increasingly more complex microcontrollers, whose performance reliability has to be check tested, according to the state of technological development, with the aid of ever more, and ever more extensive functional tests.

It is true that microprocessors in highly integrated microcontrollers, to an increasing degree, have a Joint-European Test Action Group (JTAG) interface, by way of which the functionality of the microcontroller can be tested, within the framework of the boundary scan test procedure according to Standard 1149 of the Institute of Electrical and Electronic Engineers (IEEE). However, control units, when ready for use, are positioned in a housing. Therefore, in the case of microprocessors of control units, the JTAG interface is not freely accessible from the outside, so that a hardware adaptor of a JTAG tester cannot be connected for the purpose of carrying out the boundary scan test procedure.

For this reason, the present invention proposes a special procedure for activating microprocessor 1. The JTAG interface of microprocessor 1 is marked in FIG. 1 by reference numeral 2. JTAG interface 2 is contacted via pins 3. According to the related art, the hardware adaptor (not shown) of a JTAG tester is connected to the pins 3.

To be able to utilize the advantages of the boundary test scan procedure for a motor vehicle's control unit as well, the present invention proposes a modification of microprocessor 1, so that JTAG interface 2 can be activated by a test routine that is executable on microprocessor 1.

Microprocessor 1 has PAD cells 4, which have a normal Input/Output (I/O) port function. The microprocessor uses the PAD cells as input inverters or as output drivers. PAD cells 4 can be switched as input port or as output port by the test routine that is executable on microprocessor 1. From certain PAD cells 4a of microprocessor 1, connecting leads 5 run to pins 3 of JTAG interface 2. Via connecting leads 5, a test data stream is transmitted from PAD cells 4a to pins 3 (test data in, TDI) of JTAG interface 2. Similarly, via connecting leads 5, the values present at pins 3 (test data out, TDO) of JTAG interface 2 can be read in by PAD cells 4a.

Pins 3 of JTAG interface 2 can be set and/or read by the test routine, according to a stipulated test sequence in the test routine. Via PAD cells 4a, which are switched as outputs, a predefined test data stream can be transmitted via JTAG interface 2 to microprocessor 1 or to the microcontroller. The present levels can then be measured at the pins of an interface (not shown) of the microcontroller, which can be accessed from the outside, for instance, by using a test adaptor (not shown). The levels present at these pins of the microcontroller's interface are dependent on the test data stream which is issued by the test routine via pins 3 (TDI) of JTAG interface 2 to microprocessor 1 or to the microcontroller, and on the performance reliability of the microcontroller.

The values present at pins 3 of JTAG interface 2 can be read via PAD cells 4a, which are switched as inputs. The values read can either be immediately further processed, or, for the time-being, temporarily stored for later processing. If at least one of PAD cells 4a is switched as input, by using the test adaptor, defined values can be applied to the microcontroller or to microprocessor 1, via the microcontroller's interface. The values present at pins 3 (DO) of JTAG interface 2 are dependent upon the values present at the microcontroller's interface and on the microcontroller's performance reliability.

By using the boundary scan test procedure, a greater test coverage can be achieved in control unit production (quality improvement). In addition, the test period can be shortened (cost savings), since some functional tests, which, in known methods heretofore had to be performed to check control unit functioning, are replaced by the boundary test scan procedure and can, therefore, be omitted.

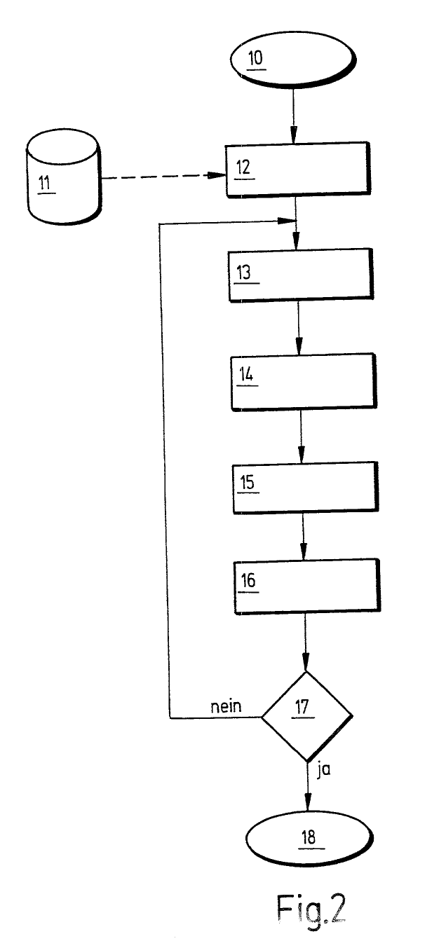

At this point, the method according to the present invention shall be explained in greater detail, on the basis of the flow chart in FIG. 2. The method begins in a functional block 10. At the beginning of the test procedure, the microcontroller is reset to a JTAG test mode. The test routine for activating JTAG interface 2 is located in an internal or external memory 11 of microprocessor 1. In a functional block 12, the test routine is loaded from memory 11 into a flash memory of microprocessor 1, for execution.

Within the framework of execution of the test routine in microprocessor 1, in functional block 13 PAD cells 4a are first of all switched as input ports and/or as output ports, depending upon the test sequence of the boundary scan procedure. In functional block 14, a predefined test data stream is applied to pins 3 of JTAG interface 2, via PAD cells 4a. This test data stream is preferably applied to the pins of the control unit. The test data stream is likewise dependent upon the test sequence of the boundary scan test procedure. With the aid of the test data stream, different test data patterns can be applied to microprocessor 1 or to the microcontroller. It is also possible to connect additional chips (CICs), having JTAG functionality, to the microcontroller (and to test them).

In a functional block 15, specific values are applied to the pins of the microcontroller's interface, in case PAD cells 4a are set as input ports. The values present at pins 3 of the JTAG interface are then read into microprocessor 1 via PAD cells 4a. In case PAD cells 4a are set as output port, in functional block 15, specific values are applied to pins 3 of the JTAG interface. The levels present at the pins of the microcontroller's interface are then read.

A test adaptor is connected to the interface, for example, to apply defined values to the microcontroller's interface, or, as the case may be, to read the levels present at the microcontroller's interface. The next step of the test sequence of the boundary scan test procedure is then selected in functional block 16.

A check is subsequently made in interrogation block 17, to see whether all test steps of the boundary scan test procedure have been executed. If not, functional blocks 13 to 17 are run through for the next test step. When execution of the boundary scan test procedure is complete, a branch is made to functional block 18 at the end of the procedure according to the present invention. The JTAG test mode is terminated by activating TRST port 3a (cf FIG. 1).

What is claimed is:

1. A method for activating a microprocessor arranged as a part of a microcontroller, within a framework of a boundary scan test procedure according to IEEE standard 1149, in accordance with a JTAG interface, comprising the step of:
activating the JTAG interface of the microprocessor in accordance with a test routine that is executable on the microprocessor.

2. The method according to claim 1, wherein I/O ports of the microprocessor are connected to pins of the JTAG interface, the method further comprising the step of:
activating the pins of the JTAG interface in accordance with the test routine via the I/O ports.

3. The method according to claim 2, further comprising the step of:
performing at least one of a setting operation and a reading operation with respect to the pins of the JTAG interface in accordance with a stipulated test sequence in the test routine.

4. The method according to claim 1, further comprising the step of:
causing the test routine to provide a test data stream to the JTAG interface within the framework of the boundary scan test procedure.

5. The method according to claim 2, further comprising the steps of:
switching the I/O ports of the microprocessor in accordance with the test routine for a predefined duration to output ports and to high; and
measuring levels present at an interface of the microcontroller.

6. The method according to claim 3, further comprising the steps of:
switching the I/O ports of the microprocessor in accordance with the test routine for a predefined duration to input ports; and
applying defined values to an interface of the microcontroller in accordance with the stipulated test sequence.

7. The method according to claim 6, further comprising the steps of:
reading values present at the pins of the JTAG interface via the I/O ports of the microprocessor; and
storing the values present at the pins of the JTAG interface in a memory area of the microcontroller.

8. The method according to claim 7, further comprising the step of:
reading out the values present at the pins of the JTAG interface and stored in the memory area via the interface of the microcontroller.

9. The method according to claim 1, wherein:
the microcontroller is arranged in a control unit of a motor vehicle.

10. A microcontroller, comprising:
at least one microprocessor capable of being activated, within a framework of a boundary scan test procedure according to IEEE standard 1149, by a JTAG interface of the at least one microprocessor, wherein:
the at least one microprocessor includes an arrangement for activating the JTAG interface by a test routine capable of being executed on the at least one microprocessor.

11. The microcontroller according to claim 10, wherein:
the arrangement includes PAD cells of the microprocessor and connecting leads from the PAD cells to pins of the JTAG interface, the PAD cells including an input/output port function.

12. The microcontroller according to claim 10, wherein:
the microcontroller includes an interface, wherein one of levels present can be measured and defined values can be applied from outside the microcontroller.
